(19) United States
(12) Patent Application Publication
(10) Pub. No.: US 2002/0104556 A1
(43) Pub. Date: Aug. 8, 2002

(54) Controlled fluid flow and fluid mix system for treating objects

(76) Inventors: Suraj Puri, Los Altos, CA (US); Iqbal S. Dhindsa, Phoenix, AZ (US); Joseph Medeiros, Santa Clara, CA (US); Phillip A. Grothe, Eden Prairie, MN (US)

Correspondence Address: Mark W. Binder, KAGAN BINDER, PLLC, Suite 200, 221 Main St. N., Stillwater, MN, 55082, US

(21) Appl. No.: 09/777,621

(22) Filed: Feb. 5, 2001

(51) Int. Cl. B08B 3/04

(52) U.S. Cl. 134/36; 134/34; 134/902; 134/100.1; 134/182

(57) ABSTRACT

A method for treating objects. The method includes supplying a fluid comprising a liquid from a fluid source through an angular direction into a manifold; and injecting a treatment chemical into the fluid at the manifold. The method also includes transferring the fluid comprising the treatment chemical to a treatment vessel through a distribution member. The distribution member distributes the fluid through a plurality of openings. Each of the openings is spatially disposed around the member such that the fluid exits through each of the openings where a lateral velocity component of the fluid through each opening is substantially equal to each other.

### FIELD OF THE INVENTION

The present invention relates to the field of treating objects by a fluid flow provided to move relative to the object, such as for cleaning or otherwise treating one or more surfaces of the object. In particular, the present invention is directed to a method and apparatus for treating an object, such as a microelectronic device, and in particular, for subjecting one or more surfaces of the microelectronic device to a fluid for treating it.

### BACKGROUND OF THE INVENTION

The present invention has been developed, in particular, for its application to microelectronic devices, such as semiconductor wafers or devices, whether raw, etched with any feature, coated, or integrated with conductor leads or traces as an integrated circuit device, lead frames, medical devices, disks and heads, flat panel displays, microelectronic masks, and the like. Such microelectronic devices have become increasingly more and more difficult to treat because they are being manufactured with smaller and smaller features that are to be treated. Moreover, uniform treatment is highly desired so as to increase the yield of such manufacturing processes.

For example, integrated circuit devices have been developed having features at sub-micron sizes, which features are to be treated uniformly. However, if after a cleaning and drying treatment process, for example, a single particle remained on a feature of such a microelectronic device, such microelectronic device could be rendered unusable.

A variety of techniques have been developed for rinsing and drying semiconductor wafers and other microelectronic devices. One technique used to rinse wafers is a cascade rinse process, which is a type of batch process rinse. Typically, a number of wafers are supported within such a rinser, such a within a wafer cassette, to be rinsed at the same time. A cascade rinser includes an inner vessel having side walls that permit fluid to spill over the top edge and into an outer vessel provided about the inner vessel. Fluid is supplied to the inner vessel, usually at the vessel bottom, to fill its internal chamber and to further cause fluid to cascade over the top edge of the internal chamber into an outer chamber. Thus, new fluid (e.g. clean water) can be supplied to rinse the wafers within the internal chamber and then to cascade from the internal chamber into the outer chamber.

A limitation of such a cascade rinser is that “dirty water” may also exist within the internal chamber, such dirty water potentially containing residual chemicals or particles that could attach to a wafer surface. Any residual chemical or particle may deposit and attach to a wafer surface when the rinse water is drained after the rinse cycle is complete. As above, such a particle or deposit can adversely affect the wafer, or any integrated circuit thereof, and may result in lower die yields from the wafers.

It has been discovered in developing the present invention that even though clean water is supplied to the cascade rinser and the cascade effect is done for a predetermined time, dirty water can still be present within the inner vessel. Such dirty water may exist and not flow through and out of the internal chamber effectively because of the fluid dynamics of the inner vessel and its components. Moreover, the manner by which the fluid is supplied may also affect the fluid movement through the inner vessel and thus create flow patterns (turbulent flow) leaving substantially dead zones of little fluid movement within which dirty water may be trapped. Again, this dirty water can result in unwanted deposits onto a wafer surface when the wafers are removed from the water or when the water is drained.

A similar problem is found in the situation where a vessel is used to immerse one or more microelectronic devices for a chemical treatment. As an example, it is known to batch process semiconductor wafers by immersing wafers within a bath of etchant where the etchant is controlled to flow along the wafers for treatment. Such an etchant may comprise any of many different acids, for example, such as hydrofluoric acid. The basic problem, like a rinsing operation, is that it is difficult, but highly desirable, to provide a uniform treatment of the fluid to the wafer surfaces. It seems also that this problem is somewhat worse in an etching situation where, commonly, highly concentrated acid solutions are used to etch the semiconductor wafers. The highly concentrated solutions can lead to surface streaking, improper etching, and the like, which effects may be caused by bad fluid flow through the vessel. Independently or in conjunction with fluid flow deficiencies, such adverse effects may be also caused by improper chemical mixing of the solution.

An example of a prior art treatment vessel is schematically illustrated in FIG. 1. Specifically, a treatment vessel 100 is illustrated comprising a vessel structure 105 having a continuous sidewall 105 and a bottom wall 106 within which an internal chamber 113 is defined. Within the internal chamber 113, one or more semiconductor wafers 101 are illustrated that may be supported within the internal chamber 113 by any conventional structure. The internal chamber 113 is also shown including a quantity of liquid 103 that is in the process of being filled within the internal chamber 113. Above the liquid 103, a headspace 104 may comprise gas that may or may not relate to the process conducted within the treatment vessel 100, which gas and headspace 104 are gradually decreased in volume to as the liquid 103 fills the internal chamber 113.

Passing through the bottom wall 106 of the treatment as a 100, a supply pipe 115 supplies liquid 103 to the internal chamber 113. The supply flow rate and pressure are conventionally controlled as provided from a source 117. A liquid distribution plate 119 is shown mounted to the outlet end of the supply pipe 115 and positioned within the internal chamber 113. Such a liquid distribution plate 119 typically extends along the bottom wall 106 of the treatment vessel 100 over a distance at least somewhat larger than the outlet end of the supply pipe 115. The liquid distribution plate 119 is illustrated with many outlet openings 111 from which the liquid 103 is actually distributed into the internal chamber 113.

In the illustrated embodiment, the supply pipe 115 is shown with a typical elbow portion at 118, which is one of many types of typical pipe structures that are encountered when installing such a treatment vessel 100. In the process of developing the present invention, it has been discovered that such typical installation structures may adversely affect the fluid dynamics of the liquid 103 as supplied within the internal chamber 113 by way of the liquid distribution plate 119. The fluid dynamics are noted in FIG. 1 as vectors of velocity of fluid flow.

Within supply pipe 115, before elbow 118, vectors 120 indicate substantially even fluid flow. However, at elbow 118, the bend causes a disruption in the even fluid flow as it travels through and from the elbow 118 to the liquid distribution plate 119. Specifically, a number of vectors 123 are illustrated representing significantly different fluid flow velocities across the pipe dimension that are caused by the elbow 118. As understood, turbulence is introduced within the fluid flow by the elbow 118, or any other structural variation common to vessel installation, which turbulence affects the fluid flow dynamics across the supply pipe in the supply pipe from the structural variation. As illustrated, the liquid distribution plate 119 is generally close enough to the structural variation such that the modified fluid flow represented by vectors 123 affects fluid flow dynamics from the liquid distribution plate 119. Specifically, fluid flow vectors 107, 108, 109 and 110 are illustrated representing distinctly different fluid flow rate values within and throughout the internal chamber 113. As determined, such an elbow 118 tends to provide greater velocity fluid flow within the side of the internal chamber 113 on the inside of the bend provided by elbow 118 (the left side as illustrated in FIG. 1). The greater velocity vectors 109 and 110 indicate this phenomenon while velocity vectors 107 and 108 show weaker fluid flow outside of the bend (the right side as illustrated in FIG. 1)

Although the liquid distribution plate 119 spreads the supply of liquid 113 over at least some of the bottom wall 106 from the supply pipe 115, the openings 111 permit the fluid flow dynamics discussed above indicating uneven fluid flow within the internal chamber 113 as it is filled or as fluid flow is maintained through the internal chamber 113 in any case. The uneveness of fluid flow from the bottom wall 106 toward the upper edge of the side wall 105 can cause the flow problems discussed above resulting in the stagnation of fluid flow in small volumes of the internal chamber 113 within which dirty water may exist and that may adversely affect a wafer 101 when it is removed from the liquid 103. Or, the uneveness of fluid flow can affect the uniform treatment of one or more wafers 103 as the fluid flow is maintained along the wafer surfaces.

All of the problems associated with treating such microelectronic devices are worsened by the development of smaller and smaller features. The tiny features are more likely to be functionally affected by any impurity (particle or chemical) or by any lack of uniform treatment. The result is a lower die yield.

### SUMMARY OF THE INVENTION

The present invention overcomes the disadvantages and shortcomings of the prior art by providing apparatus and methods for treating microelectronic devices where better fluid flow is provided through a treatment vessel and where more uniform device treatment is conducted. The present invention is based upon the improved control of fluid flow through such a vessel and the discovery of the desire to better define the fluid dynamics of such fluid flow in order to improve uniform treatment.

The present invention is applicable in any situation where one or more objects are to be treated by a clean and uniform wet process within a vessel by similar fluid flow, such as steps of rinsing, cleaning, drying, coating, etching and the like. In particular, the present invention is directed to the treatment of microelectronic devices and substrates, including, as examples, semiconductor wafers or devices, whether raw, etched with any feature, coated, or integrated with conductor leads or traces as an integrated circuit device, lead frames, medical devices, disks and heads, flat panel displays, microelectronic masks, and the like.

In accordance with one aspect of the present invention, a method for treating objects comprises providing a vessel having an internal chamber and at least one liquid distribution head operatively supported therein, the liquid distribution head having a directional opening for directing fluid flow into the internal chamber; operatively supporting an object within the internal chamber of the vessel; providing a quantity of liquid within the internal chamber so as to at least partially immerse the object; supplying liquid by way of the liquid distribution head to the internal chamber and thus raising the fluid level within the internal chamber; wherein, during the supplying step, the directional opening directs liquid without any substantial component of its initial direction of movement in the direction that the liquid within the container raises.

In accordance with another aspect of the present invention, an apparatus is provided for treating objects by fluid flow along the objects when supported therein, that includes a vessel having an internal chamber defined therein by a sidewall and a bottom wall; at least one liquid distribution head operatively supported within said vessel, the liquid distribution head having at least one directional opening for directing fluid flow into the internal chamber at a direction without a component of direction away from the bottom wall of the vessel; and a supply pipe operatively connected with said liquid distribution head and for connection to a liquid source.

### BRIEF DESCRIPTION OF THE DRAWINGS

FIG. 1 is a schematic diagram of a prior art treatment vessel including a liquid distribution plate and illustrating and uneven fluid flow within the internal chamber of the treatment vessel;

FIG. 2 is a schematic diagram of a treatment vessel in accordance with the present invention for treating one or more objects, such as semiconductor wafers, and wherein a controlled fluid flow is provided for better circulating fluid through the internal chamber and providing substantially uniform treatment of the object(s) within the treatment vessel;

FIG. 3 is a schematic diagram similar to FIG. 2 but showing a modified treatment vessel having an additional fluid flow control member provided between the liquid distribution heads and the object(s);

FIG. 4 is a cross-sectional view taken along line 4-4 of FIG. 2 illustrating one arrangement for the liquid distribution heads within a treatment vessel of the subject invention;

FIG. 5 is a graphical representation comparing pressure to distance from the treatment vessel bottom of liquid provided within a treatment vessel such as illustrated in FIG. 3 including the additional fluid flow control member;

FIG. 6 is a simplified flow diagram for a method for treating objects according to an embodiment of the present invention;

FIG. 7A is a cross-sectional view similar to FIG. 4 showing an alternative arrangement for the liquid distribution heads within a treatment vessel of the subject invention;

FIG. 7B is a cross-sectional view similar to FIGS. 4 and 7A showing yet another alternative arrangement for a liquid distribution head within a treatment vessel of the subject invention;

FIG. 8 is a plan view of a fluid flow control member as schematically illustrated within FIG. 3;

FIG. 9 is a partial schematic view of an alternative liquid distribution head in accordance with the present invention wherein fluid flow is directed substantially toward the bottom wall of the treatment vessel for improving fluid flow dynamics within the internal chamber of the treatment vessel; and

FIG. 10 is a simplified block diagram of a treatment system in accordance with the subject invention including a treatment vessel.

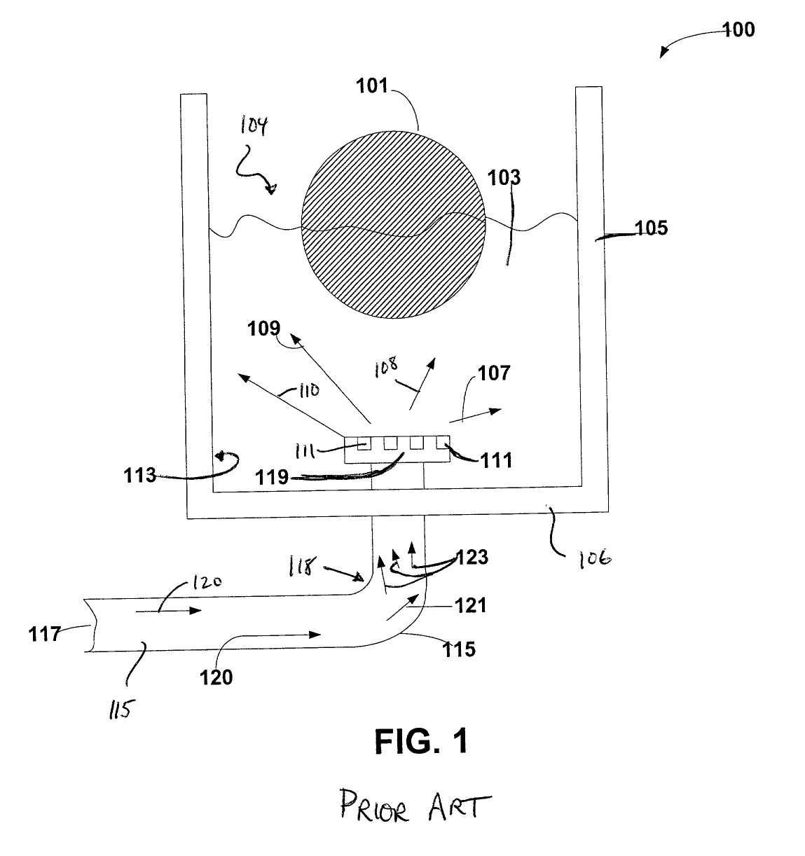

### DETAILED DESCRIPTION OF THE PREFERRED EMBODIMENTS

With reference to the figures, wherein like numerals are used to label like components throughout the several figures, apparatus and systems for treating one or more objects by fluid flow along the object(s) are provided having controlled fluid flow for improving fluid flow dynamics and providing substantially uniform treatment of the object(s). The present invention is also directed to methods of treating objects by fluid flow, wherein the fluid flow it is controlled in to improve its fluid flow dynamics and to substantially uniformly treat the object(s).

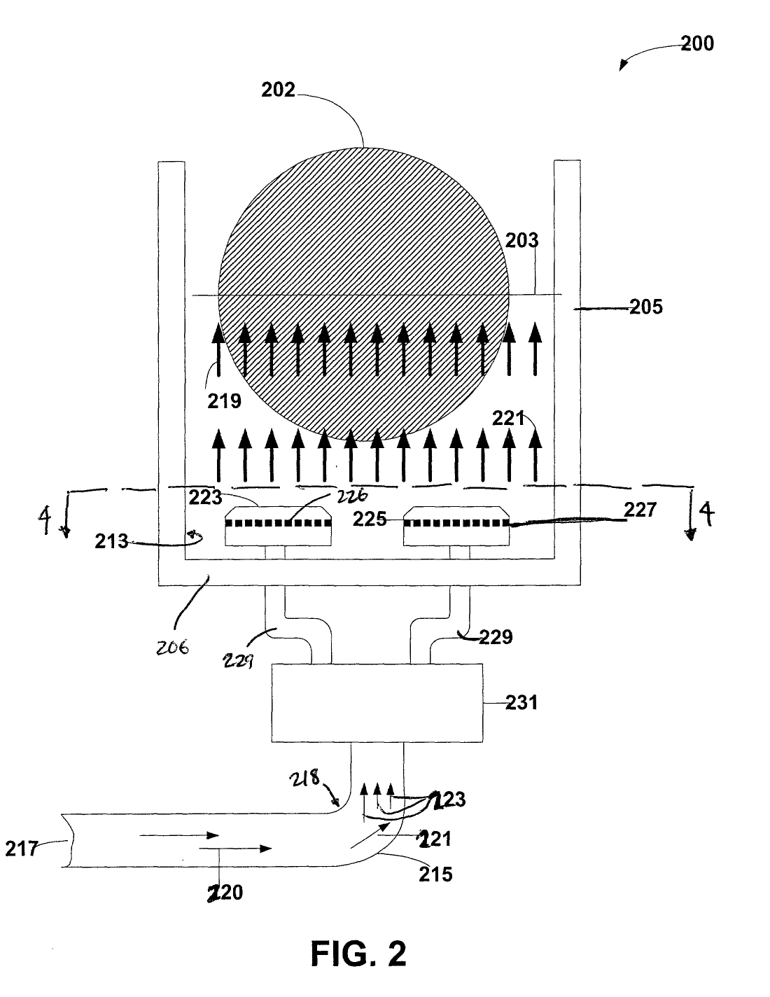

FIG. 2 is a schematic diagram of a treatment vessel 200 in accordance with the present invention designed for improved fluid flow dynamics as liquid 203 flows within an internal chamber 213 of the treatment vessel 200 along and past one or more objects, such as a semiconductor wafer(s) 202, as illustrated. Specifically, the liquid 203 is a liquid provided as part of a treatment process of one or more surfaces of the semiconductor wafer(s) 202, which liquid 203 is controlled to flow along the wafer(s) 203. The liquid 203 may comprise any such treatment liquid usable in accordance with the present invention. For example, the liquid 203 may comprise one or more chemical reactants in solution or otherwise that are provided in order to treat, i.e. etch, coat, or otherwise modify a surface characteristic, the object(s). Alternatively, the liquid 203 may comprise a cleaning fluid or a rinsing fluid for removing particles and/or residual chemicals from the object(s). In the case of one or more semiconductor wafers 202, a cleaning or rinsing fluid may be used to remove residual chemical acid and particles from wafer surfaces.

In the case where semiconductor wafers 202 are to be rinsed and/or cleaned within a treatment vessel 200, a filtered water is preferably used as the liquid 203. Such filtered water may be provided from a source 217 through a supply pipe 215 by way of liquid distribution heads 223 and 225, described below, and to cause fluid flow within the internal chamber 213 along and past the semiconductor wafers 202. Between the source 217 and the treatment vessel 200, a filter bank can be provided as known that preferably comprises a suitable combination of filters that are typically used for point of use applications. Preferably, ultra-purified water is used that is substantially free from particles greater than about 0.5 microns, and more preferably free from particles greater than about 0.2 microns, and most preferably free from particles greater than about 0.1 microns. To accomplish this, distilled water can be run through charged filters, such as are described and illustrated in U.S. Pat. No. 5,542,441 granted Aug. 6, 1996 and entitled Method and Apparatus for Delivering Ultra-low Particle Counts in Semiconductor Manufacturing, which is assigned to the assignee of the present invention, and the entire disclosure of which is incorporated herein by reference. Such a filter bank provides for ultra-purified DI water (deionized water).

In addition to running ultra-purified DI water through the treatment vessel 200, other chemical reactants or cleaning substances may be injected within the DI water as gas or liquid. An example of a cleaning enhancement chemical injected within a supply of the DI water for treating semiconductor wafers within a vessel is described and illustrated in co-pending U.S. application Ser. No. 09/311,800, filed May 13, 1999, which is assigned to the assignee of the present invention, and the entire disclosure of which is incorporated herein by reference.

Additionally, or instead, a cleaning enhancement substance may be provided within the headspace 204 above the level of liquid 203 within the treatment vessel 200. In such case, a cleaning enhancement substance can be combined with a carrier gas and injected within the headspace 204 as liquid 203 is drained from the internal chamber 213 of the treatment vessel 200 to enhance particle removal from wafer surfaces. Such apparatus and methods are described and illustrated in U.S. Pat. No. 5,772,784 granted Jun. 30, 1998 and entitled Ultra-low Particle Semiconductor Cleaner, which is assigned to the assignee the of the present invention, and the entire disclosure of which is incorporated herein by reference.

The treatment vessel 200 preferably comprises structure including a continuous sidewall 205 that along with a bottom wall 206 defines the internal chamber 213 for containing one or more wafers 202 and liquid 203. The sidewall 205 and bottom wall 206 are preferably made from similar material that is, at least on its internal surface, substantially nonreactive with liquid 203. Preferred materials include glass, polypropylene, perfluoroalkoxylvinylether (PFA), polytetrafluoroethylene (PTFE), polyvinylidene fluoride (PVDF), and others.

Moreover, and the treatment vessel 200 may comprise a cascade-type rinser, as discussed above in the Background section, wherein the structural sidewall 205 and bottom wall 206 define and inner vessel from which rinse water may cascade over the upper edge of the sidewall 205 and into an outer chamber that is defined by an outer vessel (not shown). In that way, a continuous supply of rinse water can run past the supported wafers for rinsing and cleaning them.

Otherwise, the treatment vessel 200 may provide for fluid flow through its internal chamber 213 in any other way. For example, the treatment vessel 200 may be also closed at its upper end and provided with an outlet so that fluid flows through a confined chamber within which one or more objects may be supported. Note also, that the manner by which the objects, preferably semiconductor wafers 202, are supported within the internal chamber 213 is not a specific feature of the subject invention, and that any conventional or develop technique is contemplated for use in accordance with subject invention. Moreover, the objects may be supported at any different orientation as determined to provide desired results.

In accordance with the present invention, one or more liquid distribution heads 223 and 225 are supported within the internal chamber 213 of the treatment vessel 200. Each liquid distribution head 223 and 225 is connected with the liquid source 217 by way of supply pipe 215. As illustrated, supply pipe 215 is operationally connected to provide fluid communication to the liquid distribution heads 223 and 225 by way of a manifold 231 and a pair of secondary supply pipes 229. That is, each liquid distribution head is preferably connected to a manifold 231 by way of an independently associated secondary supply pipe 229. The secondary supply pipes 229 are preferably sealingly provided through openings (not shown) through bottom wall 206 of the treatment vessel 200 so that liquid 203 is effectively provided within the internal chamber 213.

The manifold 231 provides a means by which fluid can be supplied from a single supply pipe 215 and equally distributed to the preferably plural liquid distribution heads 223 and 225 (or more). The design of such a manifold 231 can be conventional in order to provide substantially even fluid flow to each secondary supply pipe 229. Moreover, the manifold 231 may include the ability to inject one or more additional liquids or gases into the liquid supplied from source 217 in order to provide an additional treatment or cleaning enhancement substance within the liquid 203 for treating wafers 202. Furthermore, it is contemplated that any number of supply pipes may be provided to a common manifold from which one or more liquids and gases are supplied through secondary supply pipes 229 to liquid distribution heads 223 and 225. Alternatively, each secondary supply pipe 229 can be independently provided with liquid from one or more liquid or gas sources, each of which may also include further gas or liquid injectors.

As illustrated in FIG. 2, fluid flow dynamics within the supply pipe 215 can be affected by the provision of an elbow 218 that is provided in order to facilitate installation of the treatment vessel 200. Flow vectors 220 represent a substantially even flow within a first portion of the supply pipe 215 prior to elbow 218. The elbow 218 changes the fluid dynamics as represented by flow vectors 221 and 223 that show varying flow rates across the internal pipe dimension within and extending from the elbow 218 to the manifold 231. A similar situation occurs within the illustrated secondary supply pipes 229, wherein each secondary supply pipe 229 is shown with an elbow portion as well. Even with the manifold 231, the structural variations of the supply pipes 215 and 229, i.e. elbows, change the fluid dynamics as liquid is supplied to the liquid distribution heads 223 and 225. Such structural variations create turbulent flow at least through portions of the supply system that may affect how the liquid is introduced within the internal chamber 213 by way of the liquid distribution heads 223 and 225.

Thus, an important feature of the present invention is the design of the liquid distribution heads 223 and 225 to control fluid flow. As above, a preferred fluid flow is flow that is substantially laminar as fluid flows from the space above the bottom wall 206 along the wafers 202 and eventually out from the treatment vessel 200. Substantially laminar flow is illustrated within FIG. 2 by fluid flow vectors 219 and 221 that represent fluid flow having eveness across the width dimension of the treatment vessel 200 and having movement along the wafers 202 at a substantially similar rate.

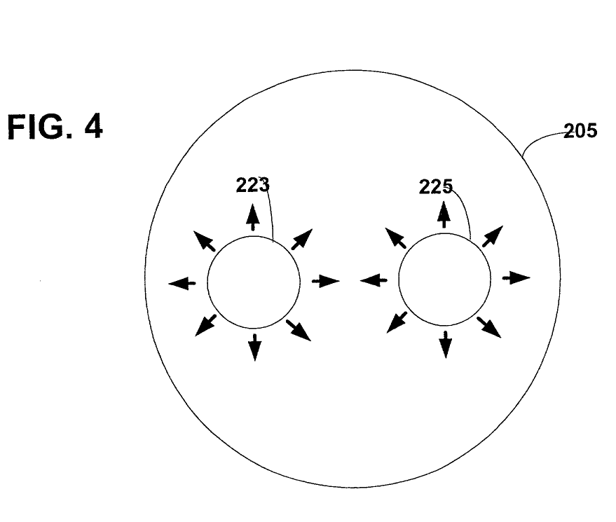

In order to achieve a controlled fluid flow in accordance with the above preferred fluid dynamics, each liquid distribution head 223 and 225 is preferably provided with a series of outlet openings 226 and 227, respectively. In particular, and as illustrated in FIG. 4, the openings 226 and 227 are preferably arranged to provide substantially radial fluid flow extending substantially evenly from each liquid distribution head 223 and 225. Preferably also, as shown, the liquid distribution heads 223 and 225 are circular as viewed from above so as to arrange the outlet openings 226 and 227 in such a radial manner. Additional rows of openings may be provided as well which may be similarly arranged or staggered, or otherwise.

The openings 226 and 227 are illustrated so as to open transverse to the direction of fluid flow within the interior chamber 213 as illustrated by vectors 219 and 221. Preferably, the openings 226 and 227 are designed so that little or no fluid flow is directed from those openings 226 and 227 in the direction of fluid flow indicated by vectors 219 and 221. That is, fluid flow through the treatment vessel 200 is typically along the direction of extension of sidewalls 205. However, fluid 203 is preferably substantially supplied into the internal chamber 213 in the direction of extension of the bottom wall 206. By removing the component of fluid supply flow from the openings 226 and 227 of liquid distribution heads 223 and 225 in the direction of fluid flow through the internal chamber 213 as represented by vectors 219 and 221, the fluid flow dynamics through the internal chamber 213 can be more evenly controlled at a substantially similar rate throughout the width of the treatment vessel 200. Differently stated, it has been discovered that fluid supply flow in the direction of fluid flow through the internal chamber 213 from liquid distribution heads 223 and 225 can inadvertently increase or cause differential fluid flow dynamics across the width of the treatment vessel 200. Thus, it is desirable to provide fluid flow from the liquid distribution heads 223 and 225 without a component of flow initially in the direction of fluid flow through the internal chamber 213. That is not to say, however, that other openings may not be provided in the direction of fluid flow through the internal chamber 213. In particular, it is contemplated to also provide some such openings, for example from the top surfaces of liquid distribution heads 223 and 225 that would work with the fluid dynamics created by openings 226 and 227 to create the overall desired fluid dynamics through the system.

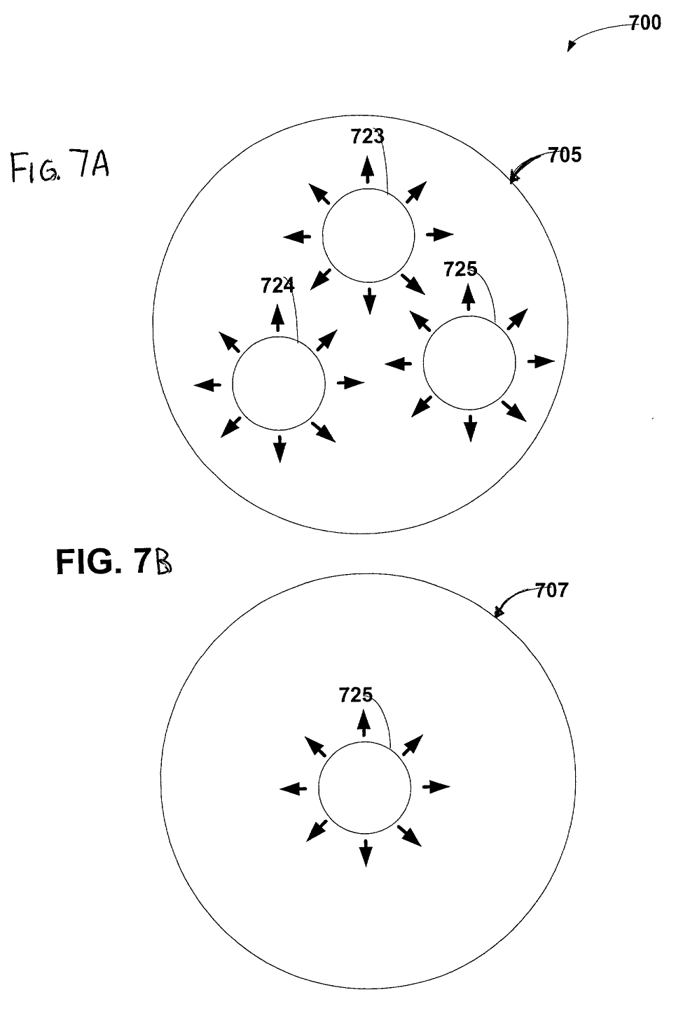

Other arrangements for liquid distribution heads 723, 724 and 725 are illustrated in FIGS. 7A and 7B. These Figs. illustrate that one or more such liquid distribution heads may be provided, as desired for a particular application. Preferably, the one or more liquid distribution heads are arranged relative to the structural design of the treatment vessels 705 and 707 and to each other in order to provide substantially even fluid flow within their respective internal chambers. It is contemplated that any number of similar or differently sized liquid distribution heads may be provided as needed for a particular application. It is preferred that the distribution heads be provided to control fluid flow as desired for a particular application, which uniform treatment is expected to be as above as substantially even fluid flow throughout the width of the treatment vessel. For other applications, other fluid flow dynamics may be desired.

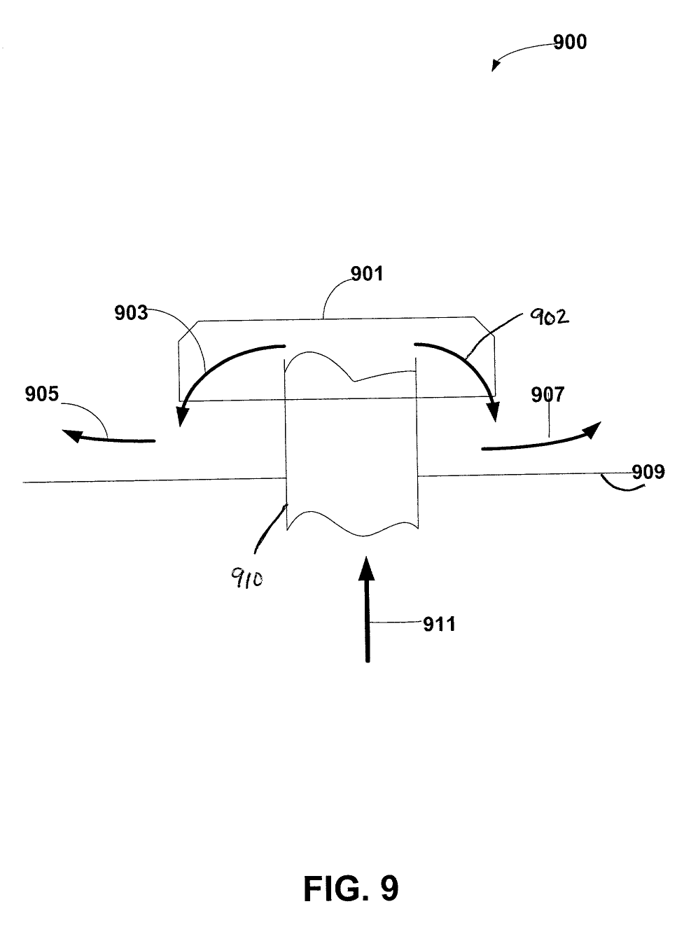

Referring to FIG. 9, another embodiment for a liquid distribution head 900 is illustrated schematically with resultant fluid flow dynamics indicated by fluid flow vectors 902, 903, 905 and 907. In accordance with this embodiment, the liquid distribution head 900 includes a top wall 901 that deflects fluid flow 901 as provided through a supply pipe 910 that is extended through a bottom structural wall 909 of a treatment vessel. As fluid flow leaves the supply pipe 910, it is deflected not only transversely (in the direction of bottom wall 909) but also downwardly toward the bottom wall 909. This feature has also been found to enhance the controlled supply of liquid from the liquid distribution heads in an even manner within the internal chamber of a treatment vessel. Moreover, the transverse and downward directed supply of liquid can be facilitated by discrete openings from the liquid distribution head 900 directed in that fashion (in one or more rows) or by merely leaving the bottom of the liquid distribution head 900 substantially open. As above as well, it is the deflection of the fluid flow 911 and the significant removal of a vertical upward component of initial fluid flow from the liquid distribution head 900 that controls and provides substantially even fluid flow within the internal chamber of the treatment vessel. Again, it is contemplated that other distinct openings may permit a limited fluid flow from the distribution head 900 in the vertical upward direction in addition to the directed fluid flow having substantially no such component.

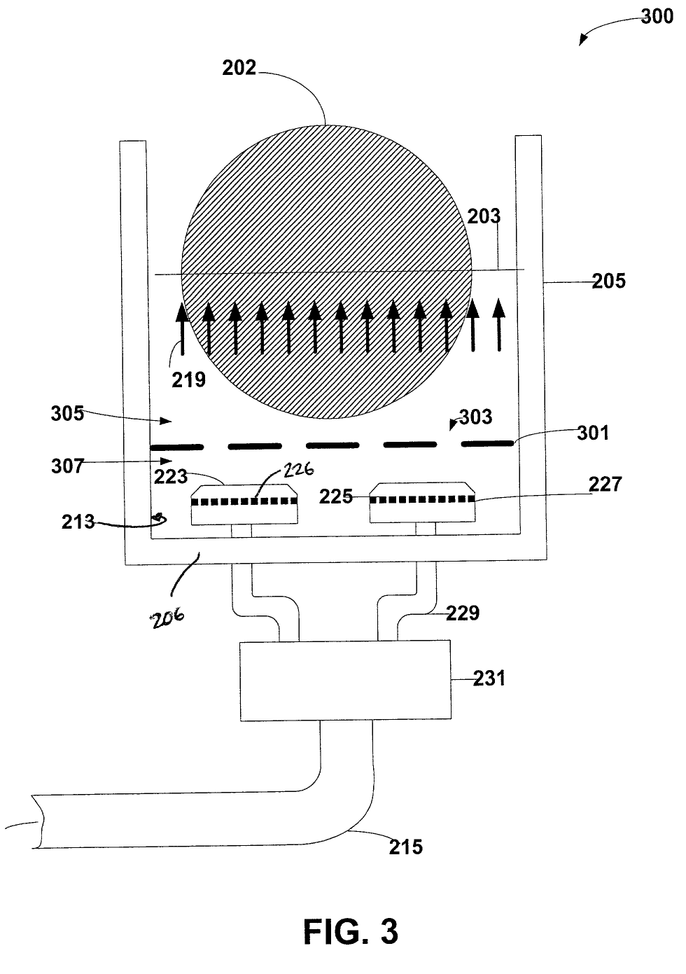

In addition to providing liquid distribution heads in any of the variations discussed or suggested above, it is further contemplated to provide an additional fluid flow control member 301 that is operatively supported within the internal chamber 313 of a treatment vessel 300 as illustrated in FIG. 3. The fluid flow control member is also preferably made from similar material as the remaining vessel structure. The manner by which the fluid flow control member 301 is operatively supported is not critical to the present invention, and any conventional or developed technique may be utilized. The treatment vessel 300 is otherwise substantially similar to that illustrated in FIG. 2 and described above.

The fluid flow control member 301 is used to divide the internal chamber 213 into an upper region 305 within which the wafers 202 are operatively supported and within which liquid 203 may be provided and a lower region 307 within which the liquid distribution heads 223 and 225 are arranged to supply liquid 203 within the internal chamber 213 for treating wafers 202. The purpose of the fluid flow control member 301 is to further enhance even control of fluid flow within the internal chamber 213 in the direction that the fluid 203 moves past the wafers 202.

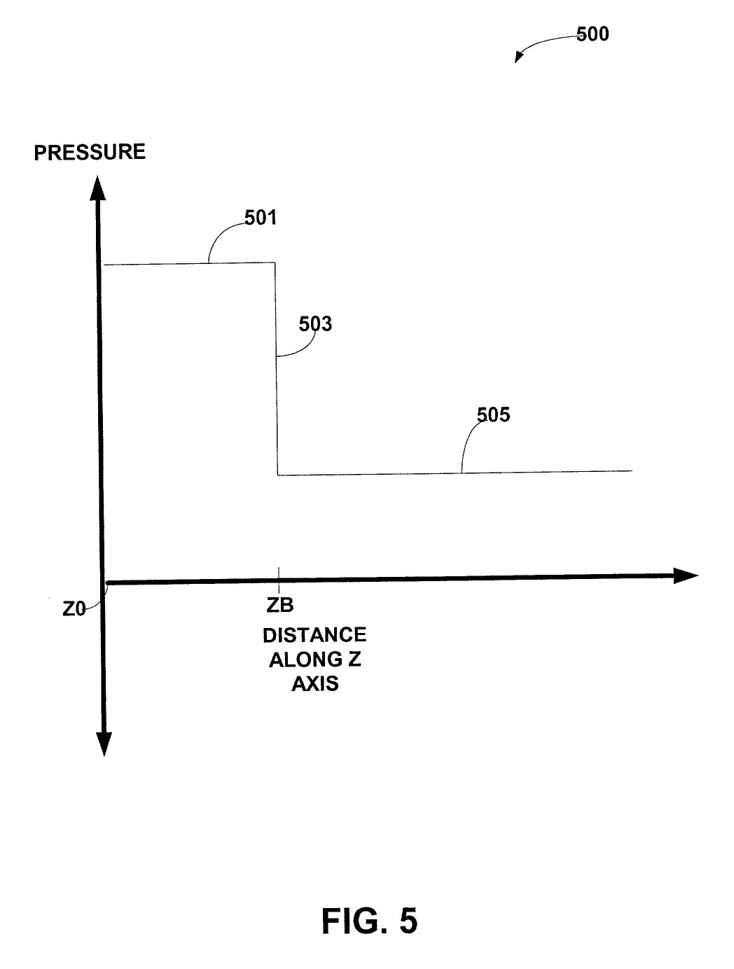

Moreover, it is preferred that the fluid flow control member 301 also create a pressure differential of the liquid 203 on either sides thereof. Specifically, it is preferred to create a pressure drop from the lower region 307 to the upper region 305. This pressure drop helps to better control fluid flow dynamics in the upper region 305 by restricting fluid flow through the fluid flow control member 301. That is, the restriction to fluid flow through the fluid flow control member 301 increases the pressure of liquid 203 within the lower region 307 as supplied by the liquid distribution heads 223 and 225 and thus permits a controlled even fluid flow from the fluid flow control member 301 and into the upper region 305. A simplified graphical representation of the pressure drop is illustrated in FIG. 5, wherein portion 501 indicates a relatively higher pressure within the lower region 307, portion 505 indicates a relatively lower pressure within the upper region 305, and portion 503 indicates a stepped pressure reduction caused by the fluid flow control member 301. The distance ZB as noted on the Z-axis represents the distance that the fluid flow control member 301 is supported from the upper surface of the bottom wall 206.

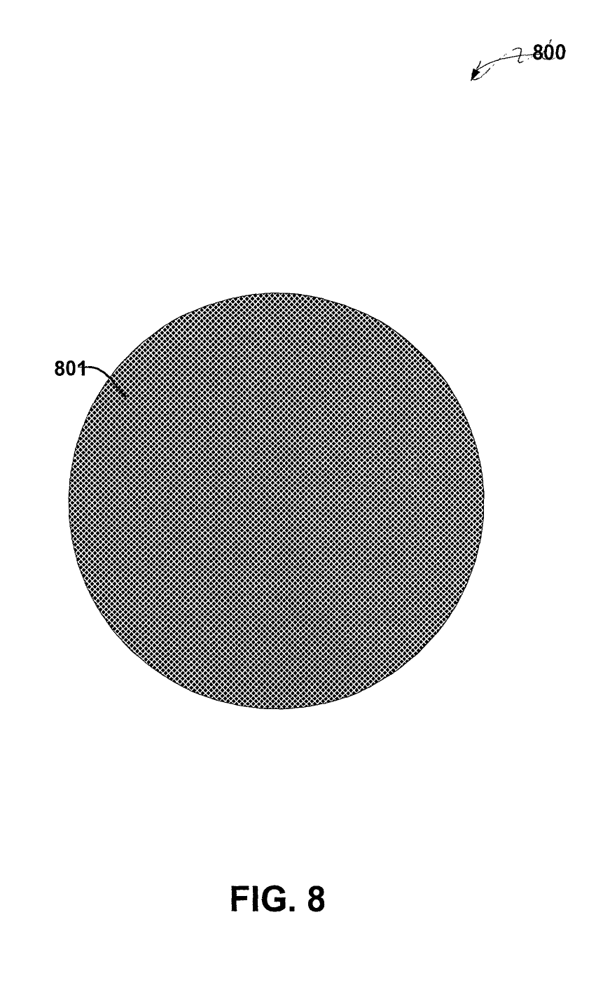

In FIG. 8, a fluid flow control member 801 is illustrated. Basically, the fluid flow control member 801 may comprise a substantially planar member that can be operatively supported across the entire width of the treatment vessel to effectively cause the desired pressure differential described above. The degree of pressure drop may be adjusted based upon any particular application, which degree of pressure drop may be controlled by the size and number of openings provided through the fluid flow control member 801. Preferably, the openings are arranged in a substantially regular and uniform manner so that uniform fluid flow will result as liquid is passed through the fluid flow control member 801. It is, however, contemplated that other arrangements for the openings may be desired where effective control is otherwise desired that may not be even across the entire surface thereof. Moreover, is contemplated that the fluid flow control member 801 may be other than planar and/or that the fluid control member 801 may comprise more than one layer of the same or different materials. Additionally, it is contemplated to utilize openings that are angled or otherwise modified to further control fluid flow from the fluid flow control member 801.

One method in accordance with the present invention for treating one or more objects within a treatment vessel is as follows. Within such a treatment vessel in accordance with the present invention, one or more objects may be provided. The objects may be immersed within (at least partially) a quantity of liquid that may or may not include a treatment liquid. The immersion liquid may be provided by way of the liquid distribution heads in any of the variations described or suggested above or it may initially be provided otherwise.

Then, for providing a treatment to the objects, a liquid (which may additionally comprise gas and/or comprise multiple constituent liquids) is supplied by way of the liquid distribution heads into the internal chamber of the treatment vessel. The action of supplying additional liquid to the initial liquid quantity for immersion causes fluid to flow in a direction through the internal chamber of the treatment vessel and along at least portions of the objects as supported within the treatment vessel. In particular, liquid is output from the liquid distribution heads without having an initial directional flow component from the liquid distribution heads in the direction of fluid flow through the internal chamber. That is, at least some fluid flow is provided from the liquid distribution heads in such manner since it may also be desirable to direct some fluid flow vertically upward.

Preferably, the liquid distribution heads are arranged and provided with openings to control fluid flow through the internal chamber at a substantially constant velocity and with substantially even fluid flow dynamics throughout the internal chamber. Most preferably, substantially laminar flow is created where the treatment liquid flows past the objects to be treated thereby.

It is also contemplated to inject one or more treatment chemicals, such as a cleaning enhancement substance, into the liquid before it is provided to the liquid distribution heads. It has been found that the liquid distribution heads in accordance with the present invention also enhance thorough mixing of such components so that not only is more even flow provided, the flow is comprised of similarly mixed components throughout. Any number of additional steps may also be conducted depending on a particular application. Moreover, as above, the treatment step may include any chemical treatment that may be used for etching, coating or otherwise modifying a surface feature of any object. The appropriate chemicals may be supplied as the supply liquid or by way of a carrier liquid with one or more chemicals injected. For rinsing and/or cleaning an object, ultra-clean DI water is preferred that may or may not include a cleaning enhancement substance.

The above sequence of steps is merely an example of how to perform one method in accordance with the present invention. Methods of the present invention take advantage of the inventive liquid distribution heads described above in carrying out the method steps. One of ordinary skill in the art will recognize many other variations, modifications, and alternatives to methods in accordance with the subject invention.

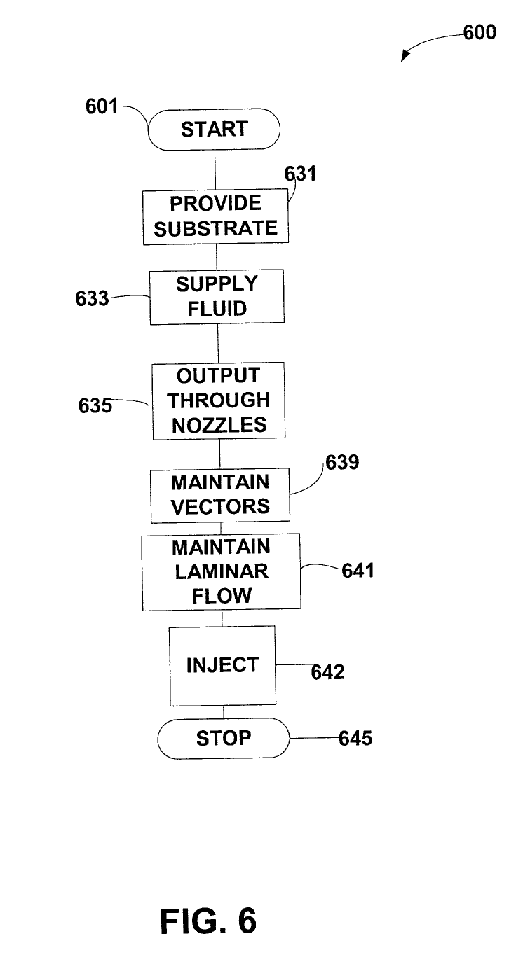

FIG. 6 is a simplified flow diagram of a method 600 for treating objects according to an embodiment of the present invention. As shown, the method 600 begins at start step 601. Next, the method includes a step 631 of providing a substrate. Such a substrate may preferably be one or more semiconductor wafers or other microelectronic devices or substrates. According to the following step 633, liquid is supplied to the substrates by way of the liquid distribution heads.

Step 635 represents the controlled output provided by the liquid distribution heads, wherein initial fluid flow from the liquid distribution heads includes fluid flow not having a component of direction in the direction of fluid flow through the internal chamber of the treatment vessel. Step 639 represents the result of this supplied technique in that even fluid flow is provided through the internal chamber of the treatment vessel. A substantially even fluid flow is preferably maintained across the internal chamber. Step 641 represents the situation where substantially laminar fluid flow is maintained.

Once the desired fluid flow is provided and maintained, step 642 represents the situation where an additional chemical is injected within the supply liquid. Again, the chemical may include and etchant, a cleaner, a surfactant, an oxidizer, or any other treatment chemical in liquid or gas form desired for a particular treatment technique. The injected chemical may be injected within a manifold, and preferably is substantially mixed as well by the fluid dynamic action of liquid distribution heads. Thus, the treatment chemical will enter the treatment vessel in a substantially mixed manner. Moreover, since the treatment vessel has substantially laminar fluid flow, the supplied fluid and treatment chemical are mixed evenly throughout the internal chamber of the vessel. That is, a homogenous mixture of supply fluid and a treatment chemical can be effectively provided throughout the treatment vessel. Step 645 merely indicates an end to that particular process, although it is contemplated that any number of additional steps may be carried out as desired.

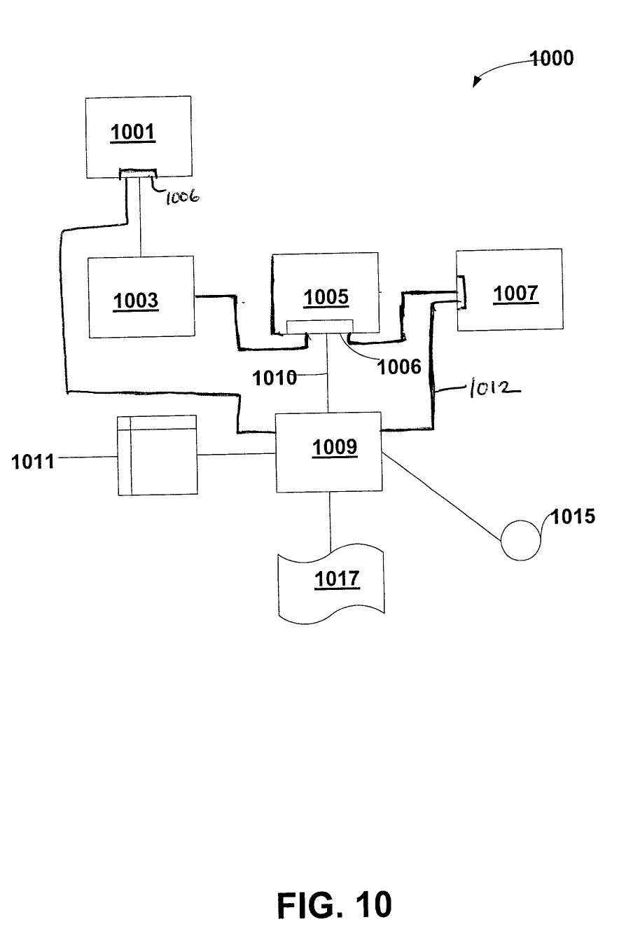

In FIG. 10, a block diagram of the treatment system 1000 is illustrated in accordance with a present invention. System 1000 is an example in accordance with the present invention including a treatment vessel 1005. It is understood that any number of different systems may be otherwise provided including such a treatment vessel 1005 and that any number of other configurations and components may be provided as desired.

The system 1000 includes the treatment vessel 1005, a controller 1009, a filter bank 1003, an injector 1007, and a fluid source 1001. The system also includes a number of flow control valves 1006 that are preferably operatively coupled to the controller 1009 and the other components as indicated. In operation as a rinser, rinse water enters the system as the fluid source 1001. A control valve 1006 at the source 1001 controls the flow of rinse water by way of the controller 1009. The rinse water preferably comprises a filtered water such as DI water (deionized water), which DI water typically originates from a DI water pad often provided outside of a wafer fabrication plant.

The filter bank 1003 may comprise any suitable combination of filters, preferably of the type used for point of use applications. The filter bank connects the rinse water source 1001 to the treatment vessel 1005 by way of another control valve 1006. This second control valve 1006 is also preferably connected with the injector 1007 so that a treatment chemical may be introduced with the filtered rinse water. The second control valve 1006 may be provided within a manifold or otherwise. As above, each of the control valves are preferably connected with the controller 1009 to provide fluid flow as desired and to effectively control when a chemical is to be injected as indicated by line 1012. The controller 1009 may comprise any known or developed control system, such as a microprocessor provided with input parameters that may be selected for a specific application and input as noted at block 1017. Any number of feedback sensors 1015 may also be connected with the controller 1009 in order to effectively control any specific treatment process. Block 1011 represents a memory module within which any number of process information parameters may be stored for utilizing a treatment vessel for any number of different treatments either independently from one another or subsequent to one another.

The aforementioned embodiments may also be used in other selected semiconductor fabrication process steps. In one embodiment, the cleaning technique occurs in pre-gate oxide cleans. Pre-gate oxide cleans were generally not performed due to the sensitivity of gate oxide layer formation. That is, conventional pre-gate oxide cleans were not performed due to the potential for introduction of particles onto the semiconductor substrate. The present technique, however, actually removes any particles that may remain on the surfaces of the substrate before gate oxide layer formation, thereby improving the general quality of the gate oxide layer. The present technique removes substantially all particles greater than about 0.5 microns, and preferably 0.2 microns, and more preferably 0.1 microns.

In an alternative specific embodiment, the present cleaning technique can be applied before other semiconductor process applications. These process applications are described in great detail in a text written by Stanley Wolf and Richard N. Tauber, Semiconductor Processing For The VLSI Era, Vol. 1: Process Technology (1986) (herein “WOLF”). For example, the present technique is applied as a pre-epitaxial, prediffusion, pre-metal, pre-poly, pre-implant, pre-photoresist, and pre-stack oxide cleaning techniques. Generally, the present cleaning technique can be applied at room temperature with trace quantities of polar organic compound. The trace quantity of polar organic compound at room temperature does not generally detrimentally influence the semiconductor or photoresists. Photoresists often dissolve during high temperature processing using solvents. As also previously noted, the present technique actually removes particles, rather than introducing them.

In an alternative embodiment, the present cleaning technique can be applied after performing a selected semiconductor fabrication process. An example of this fabrication process includes nitride deposition, polish cleans (e.g., CMP), buffered oxide etches, and metal deposition. These process steps also are described in great detail in a text written by WOLF. Additional applications of the present cleaning technique also can be applied for hydrofluoric acid last recipes and critical metal oxide silicon etches. As previously noted, the present technique actually removes particles from the semiconductor, rather being another process that introduces them.

While the above is a full description of specific embodiments of apparatus and methods in accordance with the present invention, various modifications, alternative constructions, and equivalents may be used. For example, while the description above is in terms of a method and apparatus for semiconductor substrates, it is contemplated to implement the present invention to the manufacture of all microelectronic devices and substrates including raw wafers, disks and heads, flat panel displays, microelectronic masks, and any other applications requiring high purity wet processing such as steps of rinsing, drying, cleaning, and the like. In addition, certain systems of the Figs. Are in terms of a cleaning system for semiconductors. One may, alternatively, employ such systems to other industries such as electrochemical, pharmaceutical, printed circuit board, optical devices, and any other industry that needs an improved technique to rinse and dry or otherwise treat an article of manufacture by a fluid flow technique.

Therefore, the above description and illustrations should not be taken as limiting the scope of the present invention which is defined by the appended claims.

What is claimed is:

1. A method for treating objects comprising:
providing a vessel having an internal chamber and at least one liquid distribution head operatively supported therein, the liquid distribution head having a directional opening for directing fluid flow into the internal chamber;
operatively supporting an object within the internal chamber of the vessel;
providing a quantity of liquid within the internal chamber so as to at least partially immerse the object;
supplying liquid by way of the liquid distribution head to the internal chamber and thus raising the fluid level within the internal chamber;
wherein, during the supplying step, the directional opening directs liquid without any substantial component of its initial direction of movement in the direction that the liquid within the container raises.

2. The method of claim 1, wherein the liquid is supplied to raise the fluid level within the internal chamber by way of a plurality of direction openings that direct liquid without any substantial component of its initial direction of movement in the direction that the liquid within the container raises.

3. The method of claim 2, wherein the liquid is also supplied by way of at least one other opening for directing liquid in the direction that the liquid within the container raises.

4. The method of claim 3, wherein plural liquid distribution heads are provided within the internal chamber and liquid is supplied within the internal chamber to raise the liquid level, each liquid distribution head having at least one directional opening for directing fluid flow into the internal chamber.

5. The method of claim 4, further including a step of injecting a treatment chemical into the liquid before it is supplied within the internal chamber by way of the liquid distribution heads.

6. The method of claim 5, wherein the treatment chemical is mixed by the action of liquid movement within the liquid distribution heads.

7. The method of claim 6, wherein the liquid is controllably dispensed within the internal chamber by the openings of the liquid distribution heads so that a controlled fluid flow is provided as the liquid is raised within the vessel.

8. The method of claim 7, wherein the liquid is controllably dispensed so that a substantially laminar flow is created.

9. An apparatus for treating objects by fluid flow along the objects when supported therein, comprising:
a vessel having an internal chamber defined therein by a sidewall and a bottom wall;
at least one liquid distribution head operatively supported within said vessel, the liquid distribution head having at least one directional opening for directing fluid flow into the internal chamber at a direction without a component of direction away from the bottom wall of the vessel; and
a supply pipe operatively connected with said liquid distribution head and for connection to a liquid source.

10. The apparatus of claim 9, wherein the liquid distribution head further comprises a plurality of direction openings for directing fluid flow into the internal chamber at a direction without a component of direction away from the bottom wall of the vessel.

11. The apparatus of claim 10, further comprising a plurality of liquid distribution heads operative supported within the internal chamber of the vessel.

12. The apparatus of claim 11, further including a manifold connected to the supply pipe and connected with the plural liquid distribution heads by secondary supply pipes.

13. The apparatus of claim 12, further including a treatment chemical injector for introducing a treatment chemical into the supply of liquid before it flows to the liquid distribution heads.

14. The apparatus of claim 13, wherein the injector is operatively connected to the manifold to inject treatment chemical into the manifold.

15. The apparatus of claim 14, wherein at least one of the liquid distribution heads further includes an opening directed to supply liquid within the internal chamber in a direction away from the bottom wall of the vessel.

16. The apparatus of claim 15, wherein at least one of the liquid distribution heads further includes an opening directed toward the bottom wall of the vessel.

17. The apparatus of claim 16, further including a fluid flow control member supported within the internal chamber of the vessel above the liquid distribution heads, the fluid flow control member having plural openings for permitting liquid to pass through in a controlled manner based upon the size and shape of the openings.
